(19) United States
(12) Patent Application Publication
(10) Pub. No.: US 2007/0125104 A1
(43) Pub. Date: Jun. 7, 2007

(54) Compressor system for vending devices and the like

(75) Inventor: Gregory Allen Ehlers, New Port Richey, FL (US)

Correspondence Address: REINHART BOERNER VAN DEUREN P.C., 2215 PERRYGREEN WAY, ROCKFORD, IL, 61107, US

(73) Assignee: Ranco Incorporated of Delaware, Wilmington, DE (US)

(21) Appl. No.: 11/294,940

(22) Filed: Dec. 6, 2005

(51) Int. Cl. G05D 23/32; A47F 3/04

(52) U.S. Cl. 62/157; 62/246

(57) ABSTRACT

An variable capacity compressor system operated by an adaptive energy usage management and thermal control system is provided to reduce the energy consumption and cost of operation of a vending machine. The variable capacity refrigeration system of the present invention includes the use of a variable or multi-speed compressor, a plurality of fixed capacity or speed compressors arranged in a compressor bank, a variable or multi-speed speed compressor with a plurality of refrigeration coils placed in vertical strata levels within the storage compartment, a plurality of fixed capacity or speed compressors arranged in a compressor bank with a plurality of refrigeration coils placed in vertical strata levels within the storage compartment operated by individual refrigerant media control valves, or a plurality of compressors with a plurality of refrigeration coils placed in vertical strata levels within the storage compartment coupled individually to a corresponding compressor, or combinations thereof.

### FIELD OF THE INVENTION

The present invention relates generally to vending machines, and more particularly to energy control systems for refrigerated vending machines.

### BACKGROUND OF THE INVENTION

While the service industry used to rely primarily on face to face, point of purchase contact between service personnel and consumers, the increased pace by which most consumers now operate has driven innovation in the service industry. One such early innovation that has seen tremendous growth is the automated vending machine. While initially confined primarily to break rooms and gas stations, vending machines now have found their way into school cafeterias, dormitories, hotels, office buildings, roadside rests, etc. Indeed, most anywhere there is the availability of electricity and a potential stream of consumers, vending machines may be found.

One reason for the explosive growth of the use of vending machines is that they provide twenty-four hour product availability with only periodic need to service the machine. This is because most vending machines hold an ample supply of product available for vending to consumers. Based on the location of the vending machine and the size thereof, several days or more may pass before it is necessary to refill the product supply. Such minimal service personnel contact greatly enhances the profitability of such machines. However, such profitability is reduced by the energy consumption of the vending machine, particularly during periods of inactivity when no consumers are present or purchasing products. With the introduction of new electrical pricing tariffs, the impact of energy costs will become an even greater factor in the future.

Recognizing that unnecessary energy consumption hurts the environment, the Environmental Protection Agency (EPA) has instituted an Energy Star program. For a vending machine to qualify for the Energy Star certification, various energy-saving features have been implemented in the vending machines. For example, for refrigerated vending machines that maintain the products vended therefrom below ambient temperature, vending machine manufactures have begun to implement energy-saving features that take advantage of the temperature stratification that occurs within a vending machine as cold air sinks within the product storage compartment.

Using a typical beverage vending machine as an example, the cans or bottles of soda, water, etc. are typically stored in a vertical fashion so that gravity maintains the products in the proper position for vending to the outlet, which is typically located at the bottom of the machine. Such a refrigerated vending machine includes a compressor-driven refrigeration loop to keep the contents cool. A fan is used within the storage compartment of the vending machine to circulate the refrigerated air throughout the storage compartment to cool the products stored therein. Temperature sensors placed within the storage compartment are used to control when the compressor and fan are operated to maintain the products at the proper temperature for vending.

Newer energy-efficient vending machines take advantage of the fact that cold air tends to sink to the bottom of the storage compartment within the vending machine when the fan is not running, and the fact that the products are vended from the bottom of the storage compartment of the vending machine. That is, once the storage compartment has been cooled to the appropriate temperature, the fan and compressor may be turned off for an extended period because, while the temperature at the top of the storage compartment may increase above the desired vend temperature, the temperature stratification that occurs within the storage compartment without the fan running still maintains the “next products to be vended” at an acceptable vend temperature. As a result, less energy is used by the vending machine and the products vended are still at an acceptable temperature. In other words, the vending machine takes advantage of the temperature stratification to maintain just enough of the product stored in the vending machine at the desired vend temperature, while allowing stored product near the top of the storage compartment to rise above the vend temperature, to maximize energy savings while maintaining customer satisfaction. These types of energy management and control features are taught by Konsmo in U.S. Pat. No. 5,844,808 and by Schanin in U.S. Pat. Nos. 6,243,626, 6,389,822 and 6,581,396.

While such a conservation technique is very useful, the difficulty comes in determining how much of the stored product should be kept at the vend temperature to ensure that the supply of cold product is not depleted before the temperature of the remaining products can be brought down to the acceptable temperature. One prior method utilized in vending machines to attempt to satisfy this requirement uses a calendar function, similar to that used by programmable thermostats in the home, to control when the different operating modes are switched. Specifically, the vending machine is programmed with an operating calendar profile that designates periods of normal operation and periods of conservation operation based on the day of the week and time of day. For example, a vending machine installed in a school cafeteria may be set to run in the normal mode of operation from 7 AM until 3:30 PM Monday through Friday, and to run in the conservation mode at all other times.

While such calendar functionality does decrease the energy consumption by the vending machine, it does not account for deviations in usage patterns. For example, while the calendar function may be set to operate the vending machine in the school cafeteria in the conservation mode during weekends, a weekend sporting event may well result in products being vended at unacceptably high vend temperatures. This occurs even though the conservation mode of operation typically maintains at least a portion of the products at the proper vend temperature because the rate of consumption of products during such a sporting event will likely exceed the vending machine's ability to cool the products that are stored above the temperature strata where acceptable cooling occurs. Similarly, energy is wasted during changes in, for example, the school calendar, such as spring break and teachers' institute days. This is because the simple calendar function does not accommodate changes in the operating schedule even though no one is present on those days.

To overcome this deficiency in such calendar operation, some vending machines have implemented occupancy sensors in addition to the calendar function. While the basic parameters of operation are still controlled by the calendar function, the occupancy sensor is capable of switching the mode of operation from the conservation mode to the normal mode if it detects the presence of individuals. With such an occupancy sensor, for example, the presence of people at a weekend sporting event would trigger the vending machine to enter the normal mode of operation to ensure that there is an ample supply of products in the vending machine that are maintained at the proper vend temperature. Such an occupancy sensor may also be used to switch the vending machine from the normal mode of operation to the conservation mode of operation if no people are sensed within the vicinity of the vending machine for a predetermined period of time. Such functionality would enhance the energy savings during, for example, spring break when no students are in the school during the normal school week.

While such an occupancy sensor is capable of both enhancing the energy savings and ensuring that an ample supply of products are available at the appropriate vend temperature, relying on the mere presence of people within the vicinity of a vending machine to switch to the normal mode of operation may also result in excess energy consumption. For example, the presence of cleaning personnel, security guards, etc. during periods of conservation mode of operation will switch the vending machine into the normal mode of operation. This despite the fact that only one person is present and possibly that person has no intention or desire to purchase a product from the vending machine. Since most cleaning and security personnel are present during periods that are normally designated by the calendar function as being energy conservation mode periods, the occupancy sensor may well counteract any energy savings that otherwise would have been available via the calendar function.

An additional problem with such systems relates to the refrigeration system that is used in the vending machines. Specifically, when the refrigeration control system calls for cooling, the compressor is turned on. The full capacity of the compressor is then brought to bear to cool the product storage compartment. While such capacity is very useful after the vending machine has been fully stocked with product at room temperature, it is not necessary in most other situations. Specifically, when the temperature has risen above the set point within the product storage compartment, only a small amount of cooling is required to bring the temperature back within an acceptable range. Energizing the large compressor to accomplish such a relatively small cooling task wastes energy, increases the cycles of the compressor, and increases the overall cost of operation of the vending machine.

There exists, therefore, a need in the art for a refrigeration system controlled by an adaptive energy usage management and control system for vending devices that decreases the energy consumption of the vending machine while ensuring that an appropriate supply of products to be vended are available at all times. The system and method of the present invention provides such a variable capacity refrigeration system controlled by an adaptive energy usage management and control system that may be utilized for vending machines.

### BRIEF SUMMARY OF THE INVENTION

In view of the above, it is an objective of the present invention to provide a new and improved vending machine refrigeration system that decreases the energy consumption of the vending machine while ensuring that an appropriate supply of products to be vended are available at all times. More particularly, it is an objective of the present invention to provide a new and improved vending machine refrigeration system that utilizes a variable capacity refrigeration system controlled by an adaptive energy usage profile control system to minimize power consumption while ensuring that an adequate supply of product is available at the appropriate temperature for vending.

In one embodiment of the present invention, the variable capacity refrigeration system includes a variable or multi-speed compressor unit that, under the control of a refrigeration compressor control system, maintains a proper temperature of the product and meets or exceeds Energy Star compliant product guidelines. The variable or multi-speed compressor unit operates at the most efficient energy demand level based on the thermal characteristic model of the vending device, energy cost and product demand as computed by an adaptive energy usage profile management and control system.

In an alternate embodiment of the present invention, the variable capacity refrigeration system includes a plurality of small compressor units arranged in a compressor bank, which under the control of a refrigeration compressor control system maintains a proper temperature of the product and meets or exceeds Energy Star compliant product guidelines. The compressor bank operates only the required number of compressor controls to achieve the most efficient energy demand level based on the thermal characteristic model of the vending device, energy cost and product demand as computed by an adaptive energy usage profile management and control system.

In a further alternate embodiment of the present invention, the variable capacity refrigeration system takes advantage of the vending product storage compartment vertical orientation and the thermal stratification that exists in nature and in such devices. The variable capacity refrigeration system zones this vertical product storage compartment into a plurality of vertically oriented refrigeration zones. Each zone of the vending device having separate refrigeration coils at its vertical strata level, which can individually be activated using a refrigerant media control valve. The refrigeration media is generated by a single compressor, a single variable or multi-speed compressor, or a plurality of smaller compressors in a bank being connected to a manifold from which all zones on the vertical product storage compartment are supplied through their individual refrigeration coils using their individual media control valves. These control valves and the zoning system all are under control of the refrigeration control system that computes the best combination of vertical zone location and number of zones and compressor units to operate to achieve the most efficient energy demand level based on the thermal characteristic model of the vending device, energy cost and product demand as computed by an adaptive energy usage profile management and control system.

To achieve enhanced energy savings, one embodiment of the control system a real-time clock and calendar to record, process and learn from usage patterns when customers are present. This system differentiates between people buying product versus simply being in the proximity of the vending machine. The system also learns what product or products customers are most likely to select for purchase and in what quantities they will be requesting them. To establish these usage patterns, the system of the present invention preferably operates in a “normal” mode for a predetermined learning period of time. In one embodiment, this learning period is set to 14 days to ensure that ample data points for each day of the week are provided. During this learning period, the system will have time to establish a pattern of operation for it's particular location. Preferably, during this learning period the vending machine will maintain a full inventory of ready-to-vend product.

The vending machine will optionally be equipped with a watt-hour energy consumption means and will be capable of recording the energy usage patterns in normal mode. In addition, the temperature sensors provide data relating to the thermal gain and recovery characteristics of the unit as it warms up and then cools back down when the compressor is operating. This data is monitored and recorded by the controller along with date and time data and establishes the baseline thermal characteristics of the unit. The thermal characteristics of the unit are directly influenced by the amount of product in the machine at any given time. The more inventory the machine has, the longer it will take to lower the temperature and the longer the unit will cycle off due to the stored cooling retained in each product in its inventory. The dynamics and interaction therefore of the inventory available, the external climate impact on the units thermal gain, the amount of product that is needs to have available to vend based on historical demand, all influence the control program and the how it manages the machines thermal characteristics.

After the pattern of learned activity is established for the location of the vending machine, the control system in a preferred embodiment will build and maintain a dynamic operational control calendar, and initiate a program to adjust the vending machine's thermal control operations based on the learned purchasing patterns of the consumers. The control system will manage the energy consumption levels of the vending machine to maximize savings during learned periods of little or no demand. By utilizing this artificial intelligence (AI), the system of the present invention will be capable of adapting to changes in seasons, work schedules and demands to ensure that maximum energy savings are achieved. This adaptive control program will continually monitor, record and adapt to changes in demand for product, energy usage and duration of thermal recovery cycles and track changes in real time. By applying the advanced learning algorithms, more dramatic energy savings can be achieved than by those delivered by previous fixed calendar systems. This will result in greater energy savings and reduced cost, while ensuring that an appropriate amount of product is ready to be vended.

In an alternate embodiment of the present invention, the system includes an interface to a building control system and/or other outside network. Such additional information as provided by such networks greatly enhances the ability of the system of the present invention to manage energy usage based on anticipated demand. In one embodiment which includes an interface to an existing building control system, the vending control system will receive occupied or vacant status indicators from temperature, lighting and security sub systems as well as indoor and outdoor actual temperature and humidity data. The advanced predictive algorithms of the system of the present invention will then use these data elements and indicators as additional data points to track and predict product usage patterns.

In a further embodiment of the present invention the control system of the present invention will forward all of its sensed data to a central repository or processor via a network. Alternatively, the control system will share all of its sensed data with other similar devices. In either implementation, the system of the present invention will gain expanded knowledge relating to weather, demand for product and any other computational or sensed factors which will effect its management of ready-to-vend product on hand. Access to such external sensed points and factors will provide an additional level of input to the control and energy management function of the control system of the present invention and to the network. This will greatly improve the control system's ability to predict and manage both ready-to-vend quantities of product as well as energy used by the vending machine to maintain Energy Star certification.

In a further preferred embodiment, the system of the present invention will be energy cost aware. By having access to the cost of energy being supplied to it by a load serving entity, the control system of the present invention can take advantage of real time or time of day (TOD) price changes. During low energy cost periods, the control system can operate the vending machine to store cooling in its inventory of product and then ride through high cost periods by using advanced temperature and demand management algorithms to balance product demand, energy use and ready-to-vend product availability to achieve maximum energy and cost savings. This balancing of energy cost, demand for product and temperature management will be based on learned processes, which can dynamically alter the operation of the unit based on real time and historical statistical data.

A further preferred embodiment of the system will permit it to adjust the price of the vended product in a owner specified relationship to the cost of energy and the demand level for the product. This will provide a means for recovering energy cost differentials in a traditional supply/demand market dynamic.

Other aspects, objectives and advantages of the invention will become more apparent from the following detailed description when taken in conjunction with the accompanying drawings.

### BRIEF DESCRIPTION OF THE DRAWINGS

The accompanying drawings incorporated in and forming a part of the specification illustrate several aspects of the present invention and, together with the description, serve to explain the principles of the invention. In the drawings:

FIG. 1 is an isometric illustration of a refrigerated vending machine for the vending of chilled beverages constructed in accordance with one embodiment of the present invention using a variable or multi-speed compressor;

FIG. 2 is a simplified single line controller diagram illustrating inputs to one embodiment of the controller of the present invention;

FIG. 3 is a vend profile diagram constructed by the system of the present invention during a learning period;

FIG. 4 is a simplified flow diagram illustrating the learning period of an embodiment of a control system of the present invention;.

FIG. 5 is a simplified flow diagram illustrating one embodiment of an operating mode of operation of the control system of the present invention;

FIG. 6 is a simplified flow diagram illustrating an alternate embodiment of a learning period function implement by the control system of the present invention;

FIG. 7 is a simplified flow diagram illustrating an alternate embodiment of an operational mode of the control system of the present invention;

FIG. 8 is a simplified flow diagram illustrating a further alternate operating mode of operation of the control system of the present invention;

FIG. 9 is an isometric illustration of a refrigerated vending machine for the vending of chilled beverages constructed in accordance with an alternate embodiment of the present invention using a plurality of compressors arranged in a compressor bank;

FIG. 10 is an isometric illustration of a refrigerated vending machine for the vending of chilled beverages constructed in accordance with a further alternate embodiment of the present invention using a zoned variable capacity refrigeration system and a single compressor; and

FIG. 11 is an isometric illustration of a refrigerated vending machine for the vending of chilled beverages constructed in accordance with a still further alternate embodiment of the present invention using a zoned variable capacity refrigeration system having plurality of compressors arranged in a compressor bank.

While the invention will be described in connection with certain preferred embodiments, there is no intent to limit it to those embodiments. On the contrary, the intent is to cover all alternatives, modifications and equivalents as included within the spirit and scope of the invention as defined by the appended claims.

### DETAILED DESCRIPTION OF THE INVENTION

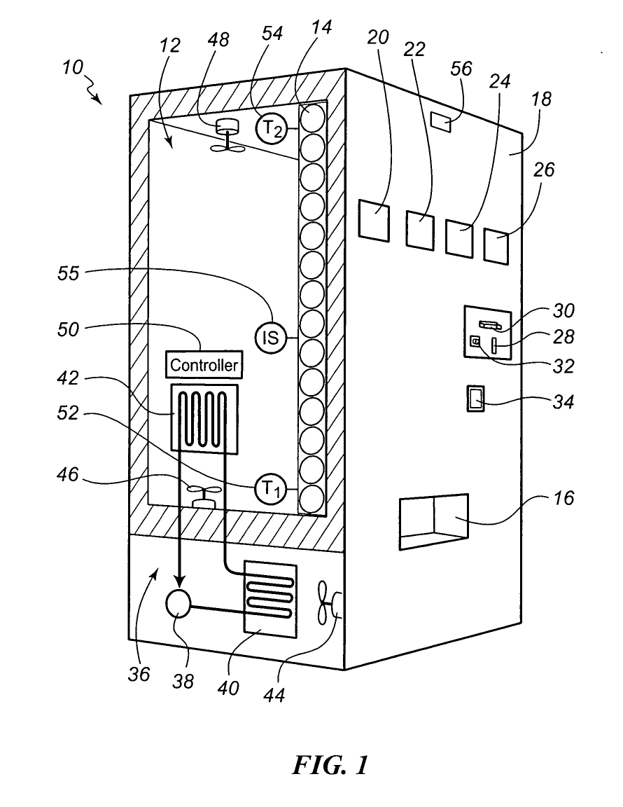

Turning now to the drawings, there is illustrated in FIG. 1 a simplified partial cut-away illustration of a vending machine for which the system and method of the present invention finds particular applicability. This vending machine 10 includes an insulated product storage compartment 12 in which the products to be vended 14 are stored. For a typical beverage vending machine, the products to be vended 14 are stored in essentially vertical stacks within the storage compartment 12. In this way a gravity feed may supply product to the bottom of the stack from which the product is vended to the dispensing compartment 16, which is typically located on the front panel 18 of the vending machine 10. As will be recognized to those skilled in the art, a particular product is vended in response to user selection of one of a number of product selection buttons 20-26 also located on the front panel 18 of the vending machine 10. The consumer pays for the desired product by inserting money in a coin slot 28 or a bill slot 30 also located on the front panel 18 of the vending machine 10. If the consumer desires to void a purchase prior to having a product 14 dispensed, the consumer may press the reset button 32 to cancel the sale. Any change due to the consumer once the desired product has been vended will be dispensed to a coin return 34.

In an embodiment of the present invention, the product storage compartment 12 is kept cool through the use of a variable capacity refrigeration system 36. In this embodiment, the variable capacity refrigeration system 36 includes a variable or multi-speed speed compressor 38, a condenser 40, and an evaporator 42 in a closed loop refrigeration system. A fan 44 may be used to keep the condenser cool during operation of the variable capacity refrigeration system 36. To circulate and cool the air within the storage compartment 12, a fan 46 is typically used to circulate air across the evaporator 42. In some applications, additional fans 48 may be used to provide circulation of the air within the compartment 12 over the products 14.

The variable or multi-speed compressor 38 may be driven at different speeds to vary the cooling capacity, and hence the energy usage, based on the cooling demands of the vending machine as determined by the controller 50. This allows more energy efficient cooling, reduces the cycling of the compressor as is common in prior refrigeration systems in vending machines, and therefore reduces the cost of operating the vending machine. The variable or multi-speed compressor unit 38 operates at the most efficient energy demand level based on the thermal characteristic model of the vending device, energy cost and product demand as computed by an adaptive energy usage profile management and control system as will be described more fully below.

In an embodiment of the present invention, a system controller 50 is utilized to control operation of the vending machine 10, including operation of the variable capacity refrigeration system 36. This controller 50 may utilize temperature inputs sensed by temperature sensors 52, 54 located at different vertical heights within the storage compartment 12. Additional sensors 55 track the inventory of each product. These sensors provide the control system with knowledge of how much thermal storage is present in the form of available product and triggers alarms when available quantities fall below restocking alarm levels. Restocking alarm level triggers, when present, can be sent over the external network to the appropriate external system. Additional or fewer temperature sensors may be used in embodiments of the present invention. These temperature sensors 52, 54 provide the controller 50 with information regarding the temperature stratification that occurs naturally within storage compartment 12 when fans 46, 48 are not run.

The controller 50 takes advantage of the variable cooling capacity of the compressor 38, this temperature stratification phenomena and the fact that the products to be vended 14 are dispensed from the bottom of the vertical stacks to reduce the energy consumption of the vending machine 10. That is, the controller 50 may allow the temperature at the top of the compartment 12 to rise above an ideal vend temperature so long as an adequate supply of products to be vended at the bottom of the storage compartment 12 are maintained at the appropriate vend temperature. A means of providing back up power to the processor, clock and calendar as well as a means of storing all data in a non-volatile memory are incorporated into the design of the controller 50. The adaptive energy usage profile used by controller 50 will be described more fully below.

As will be recognized by those skilled in the art, a typical vending machine 10 also includes front panel 18 and product selection button 20-26 illumination to attract customer attention. Since such lighting consumes energy, controller 50 also controls this illumination to reduce the overall energy consumption of the machine. As will be discussed more fully below, one embodiment of controller 50 includes a network interface to a building control system. The controller 50 receives building control system status information that dictates whether the build is in a normal or conservation mode of operation. The controller 50 utilizes this information to control the lighting of the vending machine. That is, if the building is in a normal mode of operation, there are likely to be potential consumers present, so the controller 50 will power the lighting. However, if the building is in conservation mode, there is little likelihood that potential consumers are present, and so the controller 50 may turn off the illumination.

In an alternate embodiment, the illumination is controlled based on infrared sensing of human presence in the room in which the vending machine 10 is located, similar to a motion sensor in a conference room or bathroom facility. Such a sensor 56 may be located on the front panel 18 of the vending machine 10. In an alternate embodiment, this sensor 56 may be a light sensor to detect the presence of light in the room in which the vending machine 10 is located. The controller 50 may then control the illumination based on the ambient lighting sensed by sensor 56. For example, if the lights in a break room in which the vending machine 10 is located are turned off, the controller 50 may assume that the vending machine lights do not need to be operating. When the lights in the break room are on as sensed by sensor 56, the controller 50 will then illuminate the vending machine.

In a preferred embodiment, the sensor 56 is a sensor array combining a light sensor to determine illumination plus an infrared motion sensor to determine presence of people. In such a preferred embodiment, the controller 50 will control the illumination based on a combination of these inputs. Such lighting control provided by controller 50 is independent in one embodiment from the cooling of the product control provided by controller 50. This is because the control of the variable capacity refrigeration system 36 is based on a learned demand for product while the control of the illumination of the vending machine 10 is based on the likely or actual presence of people within the vicinity of the vending machine. The illumination of the vending machine 10 is considered an attraction mechanism to entice people to purchase product, and therefore may have a completely different pattern of operation from that of the projected product demand cycle as will be discussed more fully below. Since the controller 50 will ensure that at least a minimum number of products are available at the appropriate temperature for vending, the illumination control may entice a person to purchase a product at any time regardless of the historical vend profile for that location.

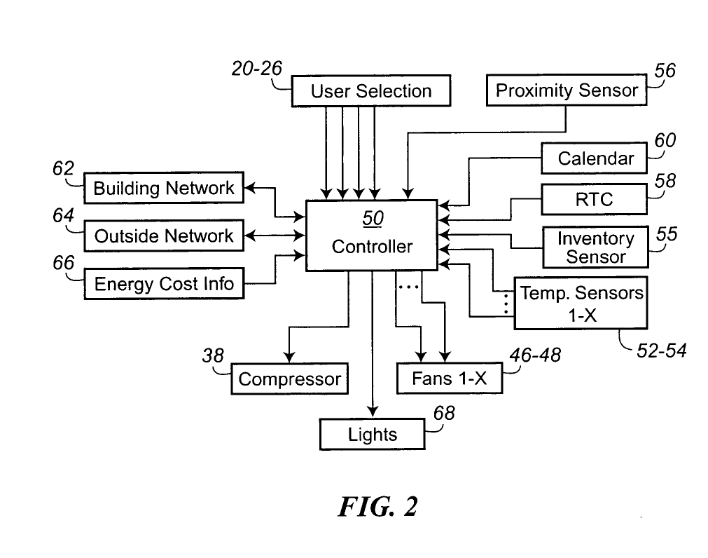

The controller 50, as illustrated in FIG. 2, receives inputs from the user selection buttons 20-26, from the proximity sensor 56, from the inventory sensors 55 and from the temperature sensors 52-54 that were illustrated in FIG. 1. In addition to these inputs, the controller 50 also receives or includes a real time clock 58 and a calendar function 60. As will be described more fully below, the real time clock 58 and calendar function 60 operate to provide the controller 50 with the required temporal information that will be used in determining a vend profile for the vending machine at its particular location.

In one embodiment of the present invention, the controller 50 also includes an interface to a building control system network 62 and/or other outside networks 64. Such an outside network 64 may include a network shared by other vending devices permitting all devices on the network to share sensed data from a plurality of points on the network. This information will allow the controller 50 to dynamically adjust and compute anticipated demand for each of the plurality of products based on a combination of sensed demand, occupancy, and weather data. The communications with the building control system network 62 provides an additional level of operational readiness by being able to determine if the facility in which the vending machine is located is in a sleep or conservation mode and if the security system is active. If such is the case, as determined by the connection to the network 62, there is very little likelihood that there will be demand for product to be vended from the vending machine. Therefore, the controller 50 may operate the vending machine in an energy savings mode.

Additionally, the controller 50 may utilize the network 62 to refresh and confirm proper clock and calendar settings, as well as provide the supplier of vended product with inventory and restocking alarm data. Additional alarm data that may be sent over the network 62 includes temperature low and high limits alarms as well as above normal thermal recovery alarms not associated with a restocking activity. These alarms ensure a higher level of availability and customer satisfaction which tie directly to higher revenues and profits per machine for the owner.

The controller 50 in a preferred embodiment of the present invention will be energy cost aware and receive energy cost information 66 from the energy provider or other authorized agent. Based on the energy cost information 66, the controller 50 can adjust the operation schedule to, for example, pre-cool the contents in the vending machine to maximize energy usage during periods of lower energy cost by running the variable or multi-speed compressor 38 at a higher speed (increased cooling capacity) while allowing the vending machine to operate in a conservation mode for a longer period of time or by running the variable or multi-speed compressor 38 at a low speed (decreased energy consumption) during the high energy cost periods. Specifically, since the controller 50 has knowledge of the historical thermal gain and recovery based on the inventory of products to be vended in the vending machine, the controller 50 can control the pre-cool period to ensure an adequate supply of products at an appropriate vend temperature will be available for the anticipated demand during the high energy cost period.

As introduced above and as will be described more fully below, the controller 50 utilizes these various inputs in its energy management programming to control operation of the variable or multi-speed compressor 38, the vending machine lights 68, and the various fans 46-48 within the energy storage compartment 12 of vending machine 10 (see FIG. 1).

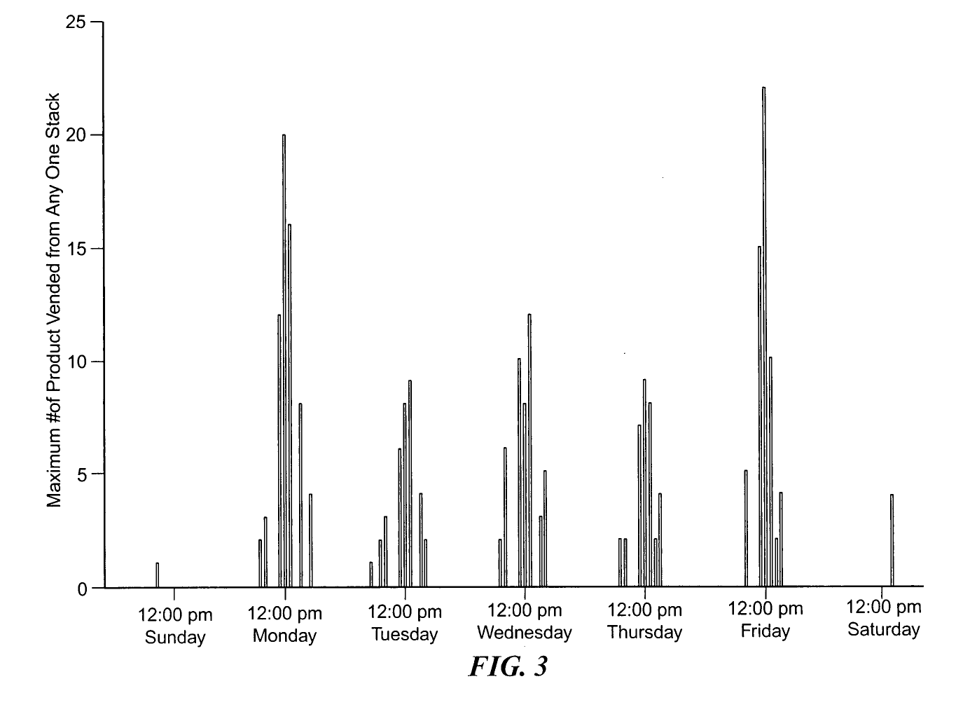

With this understanding now in place, attention is directed to FIG. 3 which illustrates an exemplary vend profile of a theoretical vending machine installed at a particular location. For this particular illustration, it is assumed that the vending machine is installed in a school cafeteria during the school year. Obviously, the vend profile for any particular vending machine installed at a particular location may vary significantly from the exemplary vend profile illustrated in FIG. 3. However, this vend profile is instructive to illustrate the function of the controller of the present invention in conserving energy consumption by the vending machine while ensuring that an adequate supply of ready-to-vend product at an appropriate vend temperature is available.

As will be apparent from an examination of this exemplary vend profile, on a weekly basis, the vend profile is fairly similar for each day of the week during the week. However, significant departures from the daily average is apparent on Mondays and Fridays. Also, the vend activities for this exemplary installation are very small on the weekend, with a higher profile on Saturday versus Sunday. Because such trends are common for many vending machine installations, a preferred embodiment of the controller of the present invention utilizes at least a full week vend profile to control the operation thereof.

Additionally, since the exemplary vending machine 10 of the present invention utilizes separate vertical stacks for each of the products to be vended, the usage bars illustrated on the vend profile represent the largest number of products vended from any particular product stack. In this way, the controller 50 will ensure that the appropriate vend temperature will exist for at least the vertical distance as would be indicated by the maximum demand for any one product. For example, while the vend bar in the vend profile for Monday at 12 PM indicates that 20 products are, on average, vended, this does not represent the total number of products vended from the vending machine. Instead, this data point represents the maximum number vended from any one vertical stack. Such a usage bar for the exemplary vending machine illustrated in FIG. 1 may actually be indicative of the vending of 80 or less cans of soda at that time (20 cans from one stack×4 stacks). By knowing the inventory and the maximum number of products vended from any particular stack, and the arrangement of products within the storage compartment 12 (see FIG. 1), the controller 50 can control the variable capacity refrigeration system 36 to operate such that the number of products within the temperature stratification at an appropriate vend temperature is ready to meet the anticipated demand indicated by the vend profile.

As will be described more fully below, the controller 50 will utilize such a vend profile to control the normal modes of operation and the conservation modes of operation so that the number of products available for vending at an appropriate vend temperature will at least meet the anticipated demand for such products at any particular time of day, any particular day of the week. For example, the controller 50 may operate the vending machine 10 in the conservation mode of operation for most of Sunday and the early morning hours of Monday. The controller will ensure that at least a minimum level of products at an appropriate vend temperature will be available during the morning hours of Sunday, which might reflect a purchase by cleaning or maintenance personnel who take a break at this time on Sunday. Operation during each of the weekdays also indicates that a higher number of products at an appropriate vend temperature must be available mid-morning, morning, and that a much higher number of products must be available through the lunch hour and at the end of a school day. However, the vend profile also indicates that the vending machine may be operated in the conservation mode for several hours during the normal school day.

After the school day has completed, demand for products at this particular location drops off such that the vending machine may be operated for an extended period of time in the conservation mode of operation. This despite the fact that there may be several people present in the proximity of the vending machine during such after school hours for, e.g., wrestling practice or other after school activities during which no one purchases products from this particular vending machine. This presents a significant advantage over systems that utilize presence of people as opposed to consumer-buying historical data to determine when the vending machine should operate in a normal versus a conservation mode of operation. Similarly, the demand during the lunch hour varies from day to day in a fairly predictable pattern despite the fact that the same numbers of people may well be in proximity to the vending machine during such lunch periods. Whatever the reason for such different buyer profiles during different days of the week, the controller of the present invention takes this into consideration, to conserve more energy from Tuesday through Thursday because the demand is lower. This is unlike prior systems that merely utilized a single time of day calendar function to determine periods of normal versus conservation modes of operation.

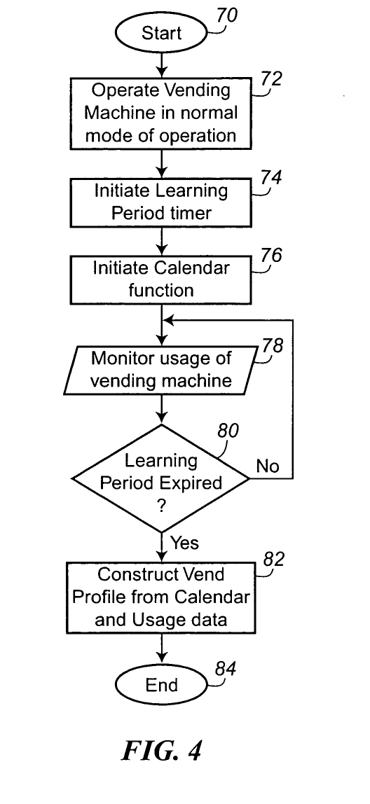

In order to establish the vend profile that will be used by the controller 50 of the present invention to control the power consumption of the vending machine, primarily by controlling operation of the variable capacity refrigeration system 36, an embodiment of the controller 50 of the present invention utilizes the method illustrated in FIG. 4. Upon initiation of this learning function 70, the controller initially operates the vending machine in a normal mode of operation 72. Even during this learning period, the controller operates the variable or multi-speed compressor to maximize energy efficiency and reduce compressor cycling. The controller then initiates a learning period timer 74 and the calendar function 76 to begin constructing the vend profile for use in later control of the power consumption of the vending machine. In this way, the vend profile will take into account different purchasing behavior of consumers at a particular vend installation throughout, for example, a week. During this learning period, the controller 50 monitors and records usage of the vending machine 78 to determine the number and types of products vended, the energy used, the thermal gain and recovery time, as well as the inventory of product.

Once the learning period has expired 80, the controller 50 constructs the vend profile from the calendar and usage data 82 before ending 84. While the learning period may vary based on the location of the insulation of the vending machine, a preferred embodiment of the present invention operates in the normal mode of operation for a period of 14 days to enable the system to have time to establish a pattern of operation for the particular vending installation location. Other embodiments of the present invention may use longer or shorter periods of time for the learning period.

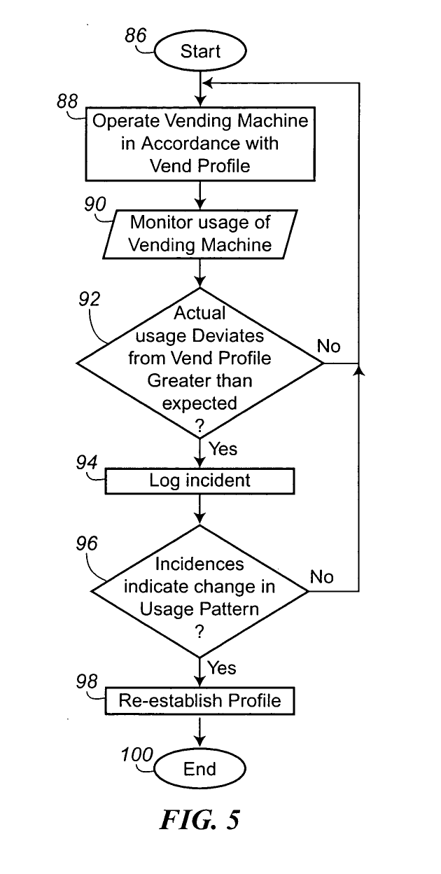

Once the controller 50 has constructed the vend profile from the calendar and usage data, it operates to control the energy consumption of the vending machine in accordance with the programming illustrated in FIG. 5. Once the operating mode has been initiated 86, the controller 50 operates the vending machine in accordance with the vend profile 88. During this period of operation, the controller continues to monitor and record product and energy usage data and inventory of the vending machine 90. When the actual usage of the vending machine deviates from the vend profile by an amount greater than expected for normal usage variances 92, the controller 50 logs the incident 94. If the number of incidences of deviation from the vend profile indicates a change in the usage pattern 96, the controller 50 operates to reestablish the profile 98 before ending 100. Such changes may occur, for example, with changes in the seasons, the school calendar, summer break, etc.

This adaptive feature, once the original vend profile has been established, greatly enhances the energy efficiency of the system as it allows for the vend profile to be varied based on actual demand for vended product as such demand changes over the course of time. However, this system also prevents a single significant deviation in the actual usage to disrupt the vend profile. For example, if the school were closed for a single day out of the week, this single departure from the expected vend profile, while significant, would not change the vend profile. This is important because the next day when the students are back in school, they are likely to purchase products in accordance with their historical trend reflected by the vend profile. The interface to external networks and systems further increases the controllers ability to recognize one time special events and fine tune the controls schedule to take advantage of the deviations when ever possible.

To balance the desire for energy savings with the requirement that a sufficient supply of product at an appropriate vend temperature be available, one embodiment of the controller of the present invention is quicker to increase the amount of product maintained at an acceptable vend temperature as demand increases, and is more slowly adaptive to decreases in demand. This will ensure maximum user satisfaction, particularly in situations where, in the exemplary installation in a school cafeteria, kids are out of school for a longer period of time, e.g. spring break, but return a week later. During spring break, the demand for vended products will obviously decrease significantly, and a nearly normal return to the vend profile will result once the students are back from spring break. This may be accomplished in one embodiment by decreasing the number of products ready to vend based on a running decreasing average for each vend period. The number of data points for the running average may vary based upon expected usage and variances in the week-to-week schedule of anticipated usage at a particular vend installation. Increases, however, may be based on a single data point to allow rapid recovery from the spring break example.

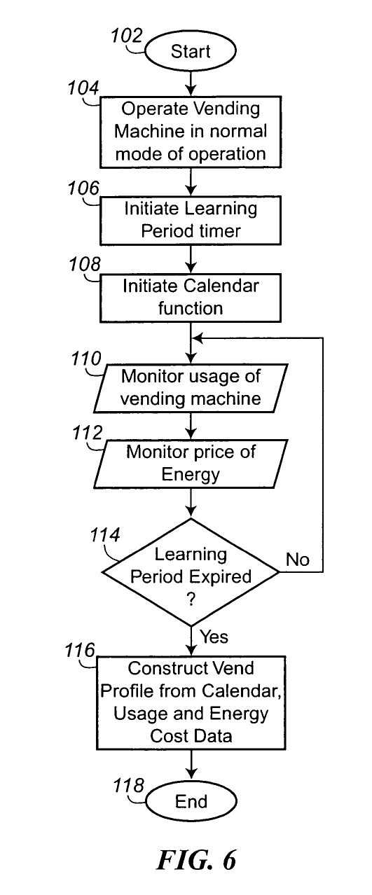

In an alternate embodiment, the establishment of the vend profile operates as illustrated in FIG. 6. Once this process has begun 102, the vending machine is operated in a normal mode of operation 104 similar to the previous embodiment. Similarly, the learning period timer is initiated 106 as is the calendar function 108. Likewise, usage of the vending machine during the learning period is monitored and recorded 100. Unlike the previous embodiment, however, this embodiment of the present invention is energy cost aware, and therefore also monitors and records the price of energy, the amount of energy used, the thermal gain and recovery times and associated cost as well as the product inventory 112 during the learning period. This process is beneficial when the electric utility utilizes a fixed time of day rate tariff. Once the learning period has expired 114, the controller constructs the vend profile from the calendar, usage, thermal, inventory and energy cost data 116 before ending 118. Unlike the vend profile that would have been constructed in the previous embodiment, the controller in this embodiment will utilize the thermal inertial of the product to “store” cooling, or pre-cool, the products during low energy cost periods by operating the variable or multi-speed compressor 38 at a higher speed (higher cooling capacity) preceding high energy cost and high demand periods.

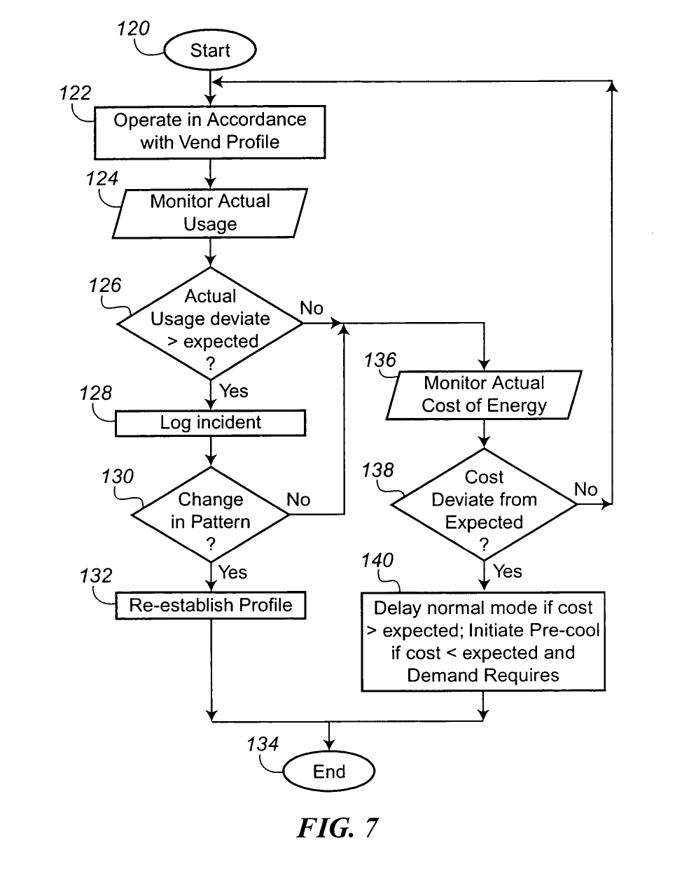

With such a fixed time of day rate tariff, operation of the controller 50 in one embodiment proceeds as illustrated in FIG. 7. Once this process has begun 120, the controller operates the vending machine in accordance with the vend profile 122. The actual usage and inventory of the vending machine is monitored and recorded 124 as with the previous embodiment. Similarly as with the previous embodiment, if the actual usage of the vending machine deviates greater than expected 126, an incident is logged 128 to determine if a change in the vend profile 130 has been indicated. If so, the controller reestablishes the profile 132 before ending 134. To reestablish the profile the controller may re-enter the learning period, or may simply adjust the profile based on the deviations monitored. As discussed above, this modification may be slow down, quick up, may be running average for all adjustments, etc. Also as mentioned above, data from external networks can aid the controller in taking advantage of one time or special events.

To take into account the potential deviations in the cost of energy, the controller also monitors the actual cost of energy 136. If the cost of energy deviates from the expected cost as developed during the vend profile learning period 138, the controller 50 operates to vary the operation in anticipation of such variance so as to minimize the expense of operating the vending machine while still ensuring that an adequate supply of product at an appropriate vend temperature is available. In the exemplary embodiment illustrated in FIG. 7, the controller operates 140 to delay the normal mode of operation if the cost is greater than expected if such delay will not result in an inadequate supply of product available for vending at an appropriate vend temperature. That is, the controller 50 may operate the variable or multi-speed compressor 38 at a lower speed than it might otherwise to conserve energy consumption and reduce cost, while still ensuring that an adequate supply is available. If, on the other hand, the actual cost of energy is less than expected, the controller 50 may operate to initiate pre-cooling of the stored products to take advantage of the lower cost of energy if the anticipated demand so requires. That is, the controller 50 may operate the variable or multi-speed compressor 38 at a higher speed than it might otherwise to store cooling capacity to take advantage of the lower cost of cooling in anticipation of need.

By taking into account the cost of energy, the controller can alter the operation or scheduled operation of the vending machine to minimize the overall cost of operating the vending machine. If power is relatively cheap now but will be high from e.g., 1 PM to 8 PM, the controller may operate the variable capacity refrigeration system at a higher speed (increased cooling capacity) to drop the temperature of the product below its normal levels to provide for a cold reserve (pre-cooling) that will keep the vending level product cool during the period of high energy cost. By restricting or lowering the speed of operation of the variable capacity refrigeration system during the high cost of energy period, or by eliminating its operation during such a period altogether, the controller can avoid or at least reduce the impact of the peak pricing period and result in an overall lower cost of operation without any reduction in consumer satisfaction. Pre-cooling and regulated or gradual post high cost period recovery are both functions that an embodiment of the controller of the present invention provides in its thermal management programming.

If, instead of a time of day rate tariff, the energy utility supplying the vending machine utilizes a variable or real time pricing structure, the process is slightly modified. In the variable tariff, the controller receives day ahead (24 hour pricing signals) from which the controller can plan the next day's operating schedule. In such an environment, the controller 50 modifies the vend profile so as to operate the variable capacity refrigeration system based on demand, by taking advantage of low cost pre-cooling and post high cost recovery strategies modified on a daily basis taking into account the vend profile and data from external networks when available.

On a real time rate tariff system, however, the price of energy is typically set at 45 minutes into the hour for the next hour. As such, the controller then has 15 minutes to adapt the operating profile for the next hour. For example, if a controller, based on the vend profile, plans to initiate a higher capacity cooling cycle at 1 PM, but the rate information at 12:45 AM indicates that the cost of energy will increase substantially at 1 PM, the controller may initiate a pre-cool cycle based on the lower current cost of energy, and reduce the amount of time or the capacity that the controller will have to operate the variable capacity refrigeration system during the next hour of higher energy cost. Even with such a real time rate tariff system, however, repeated patterns of energy cost may be realized because the price of energy typically follows the demand curve for the utility, and therefore will typically occur during the same times everyday. The controller takes this historical data into account and utilizes pre-cooling where appropriate to gain operational efficiency and reduced operating costs.

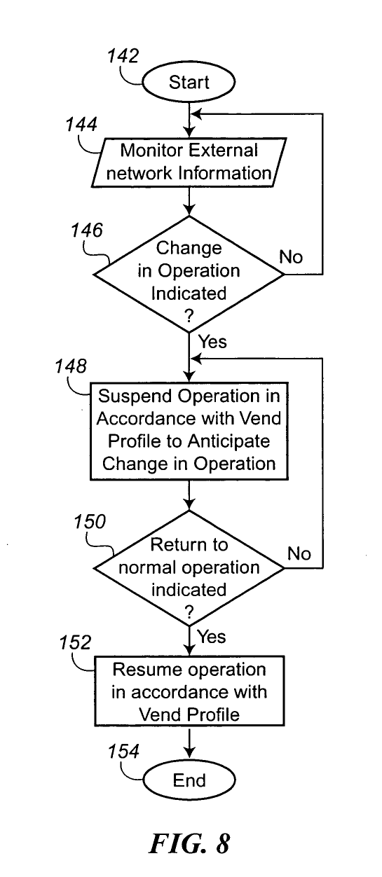

In an alternate embodiment which includes at least one connection to an external network for the receipt of information therefrom, the controller 50 may operate to control the variable capacity refrigeration system in accordance with the flow of FIG. 8. Once this flow has been initiated 142, the controller monitors the external network information 144. If this network information indicates a change in operation, for example the building is set to a conservation mode of operation because the school has been let out for spring break, the controller 50 may suspend operation in accordance with the vend profile to anticipate the change in operation indicated by the external network information 148. In this way, the controller may take advantage of this knowledge to immediately suspend operation in accordance with the vend profile as the demand for vended product during spring break is likely to drop to near zero during the period that the building itself is in a conservation mode of operation. The controller 50 can then operate the variable or multi-speed compressor 38 at its lowest capacity, and hence its lowest power consumption and cost.

Once the monitored network information indicates a return to normal operation 150, the controller 50 may then resume operation in accordance with the vend profile 152 before ending 154. This knowledge provides a significant advantage in this embodiment because actual significant changes in the consumer activity in view of external factors such as holidays, vacations, etc. may result in significant reduction in energy consumption during such periods by recognizing that an exceptional event has taken place that should rightly suspend operation in accordance with the vend profile.

Such an external interface to a building control system will provide input to the controller 50 as to what the normal operational hours are. This interface will provide additional input to the controller that will let it know if additional or reduced operating hours are in effect and for what period of time it will remain in effect. This information will be used by an embodiment of the controller of the present invention in conjunction with the vend profile and actual consumption data to develop and fine tune predictive usage pattern for the vending system so as to maximize energy conservation while ensuring an adequate supply of product ready to be vended is available. For example, if the controller receives information for the building control system that the alarm system of the building is set to “unoccupied,” the controller can assume that no product demand will exist from any employees or students, and may therefore operate in a conservation mode of operation. On the other hand, a department store that is having a midnight madness sale will alter its building management and security system to permit the extended hours of operation. This information will be received by the controller and applied to its operational plan to increase the amount of product ready to be vended in anticipation for such extended hours by, e.g. increasing the speed, and therefore the capacity, of the variable or multi-speed compressor 38.

In an embodiment that includes an interface to an outside network, the controller 50 may receive and utilize information relating to an area or regional impact. For example, information such as weather data can dramatically affect the demand for consumption, especially in vending machines that are located outside. The controller can use such weather information to adapt the operating profile. This will allow the controller to take advantage of the fact that demand for a cold beverage on a hot summer day will be much greater than if the weather patterns for the afternoon are for heavy rain and cooler temperatures. These external factors available from outside networks can provide additional input data points to the controller of the present invention to allow it to better predict the demand and need for a projected quantity of product, ready to be dispensed, while allowing it to conserve energy at every opportunity. Such external factors that may influence the consumption patterns and demand are not limited to weather. Other weather factors such as humidity levels, UV indexes, wind speed and direction can all be input and used by the predictive demand control system of an embodiment of the present invention. Other factors not related to weather that could impact usage patterns include localized social events such as State or County fairs, elections, religious events, sporting events, local holidays, events of national impact, local strikes or labor disputes.

Another point of disruption in the normal operation of the vending machine that may be taken into account by the control system is the restocking of the vending machine itself, especially if it is restocked with product at room temperature. In one embodiment of the present invention, the controller will enter a period of thermal recovery during which it may have no product at a suitable temperature to vend. This embodiment of the controller will look at a number of factors to determine how best to cool the product so that it will be ready to vend at a period of anticipated demand. Such inputs may include the cost of energy, the anticipated demand as indicated by the vend profile and as may be adjusted by external network information, the anticipated recovery time for the thermal mass to be cooled, cooling capacity at various speeds of the compressor 38, etc. The controller will then take these factors into consideration to implement the most cost and energy effective scheme to recover its thermal capacity in a timely fashion. Similarly, this embodiment of the controller may implement a similar process following an extended power outage.

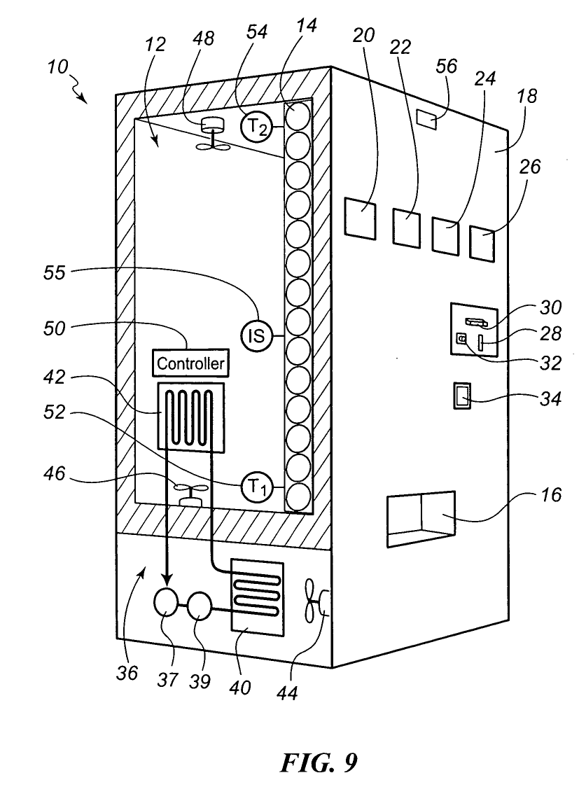

In an alternate embodiment of the present invention as illustrated in FIG. 9, the variable capacity cooling is provided by a plurality of small compressor units 37, 39 arranged in a compressor bank instead of using a variable or multi-speed compressor 38. These individual compressors 37, 39 are controlled by the controller 50 to maintain the proper temperature of the product and meet or exceed the Energy Star compliant product guidelines. Specifically, the controller 50 operates only the number of compressor units 37, 39 required to achieve the most energy efficient utilization of the needed cooling capacity of the system based on the thermal characteristic model of the vending device, energy costs and product demand as computed by the controller 50 as described in detail above.

The operation of this alternate embodiment illustrated in FIG. 9 is similar to that described above with the variable or multi-speed compressor 38 in that the controller 50 has the capability to increase the cooling capacity of the refrigeration system by energizing additional compressor units when the demand profile requires increased cooling. However, when the cooling demand is less, the controller 50 may operate fewer of the compressor units to provide only the required amount of cooling at a much lower energy consumption under such periods of lighter demand for cooling capacity. Similarly, the controller 50 has the ability to utilize fewer of the compressor units when the cost of energy is high to reduce the cost of operation, and to utilize more of the compressor units when the cost of energy is low to take advantage of the lower cost during such periods.

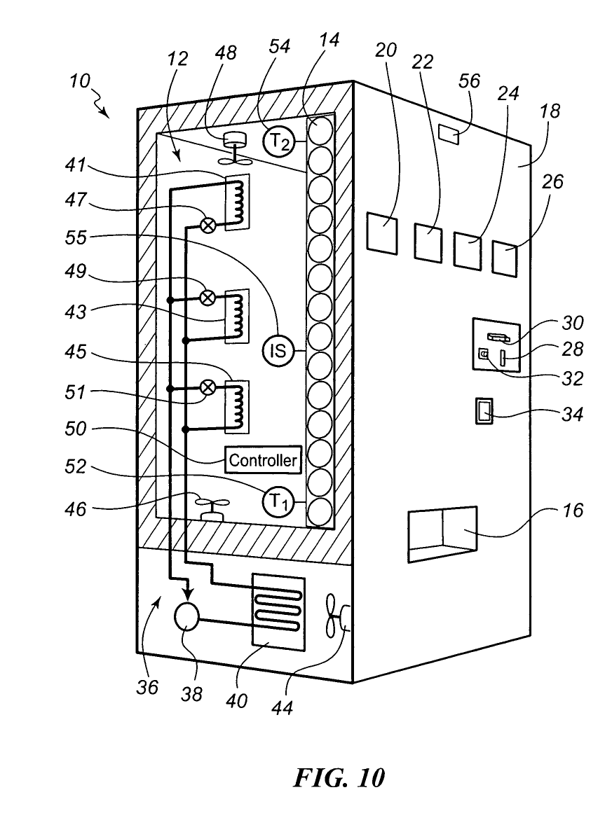

A further alternate embodiment of the system of the present invention is illustrated in FIG. 10, to which attention is now directed. While this embodiment of the present invention is illustrated as utilizing a variable or multi-speed compressor unit 38 under control of controller 50, this embodiment primarily takes advantage of the vending product storage compartment vertical orientation and the thermal stratification that exists in nature and in such devices. Specifically, this embodiment of the present invention zones the vertical product storage compartment 12 into a plurality of vertically oriented refrigeration zones. In each of these refrigeration zones, separate refrigeration coils 41, 43, 45 are positioned at the corresponding vertical strata level. As additional cooling is required, i.e. higher in the product storage compartment 12, each of the individual refrigeration coils can be activated in turn using a refrigerant media control valve 47, 49, 51 to individually operate the coils 41, 43, 45, respectively.

As increased demand based on the vendor profile, etc. is determined, the controller 50 can individually operate the refrigerant media control valve in the associated strata to provide cooling within and below that strata level. For example, during periods of low demand when cooling is required to maintain an adequate supply of product to be vended, the controller 50 may operate the refrigerant media control valve 51 to provide cooling only in the lowest strata within the product storage compartment 12. As additional demand for product occurs or is anticipated, the controller 50 may operate the refrigerant media control valve 49 to also begin cooling via coils 43 to increase the number of products in the higher vertical strata that are brought to the appropriate vend temperature. Finally, the controller 50 may operate the refrigerant media control valve 47 to provide additional cooling in the uppermost strata during periods of high demand such as, for example, after the vending machine 10 has been restocked, during periods of high demand, low energy cost, etc. While, in one embodiment, the controller 50 operates the individual refrigerant media control valves 47-51 to utilize a combination of the refrigeration coils 41-45, the controller 50 may also operate individually any of these refrigerant media control valves 47-51 to provide cooling from any one or combination of the coils 41-45.

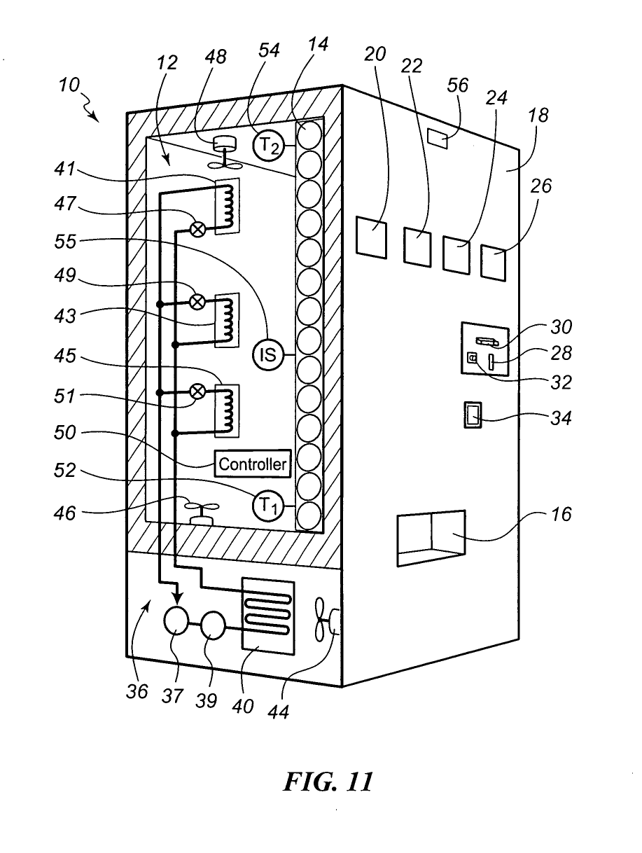

While the embodiment of FIG. 10 illustrates the usage of the variable or multi-speed speed compressor 38, it should be stated that this embodiment may also be operated with a single capacity or speed compressor or with a plurality of smaller compressor units arranged in a compressor bank as illustrated in FIG. 11. In such cases where variable capacity is provided either through variable or multi-speed compressor 38 or through a number of smaller compressor units 37, 39 arranged in a compressor bank, the controller 50 has the ability to provide increased cooling capacity during periods of high demand and/or low energy costs while reducing the costs and energy consumption during periods of higher energy costs and/or lower demand as described above.

While the embodiment of FIG. 11 illustrates the usage of a plurality of smaller compressor units 37, 39 arranged in a compressor bank to supply refrigerant to a common manifold from which each of the individual refrigeration coils 41-45 are supplied, it should be noted that the system of the present invention also contemplates individually coupling the smaller compressor units with a single refrigeration coil placed at the various strata levels within the compartment 12 and individually operating them by the controller 50 when cooling in each of the individual strata levels is required. This configuration eliminates the individual refrigerant media control valves and instead allows each individual compressor unit to operate a single refrigeration coil within the storage compartment 12. As additional cooling requirements are demanded by the vend profile, etc., the controller 50 operates additional compressor units to provide the additional cooling capacity necessitated by the increased demand or, advantageously, during periods of lower energy costs. Similarly, during periods of lower demand or during periods of higher energy costs, the controller 50 operates fewer of the individual compressor units to provide only that amount of cooling necessary under such conditions.

As will now be understood by those skilled in the art from the foregoing description, the variable capacity refrigeration system of the present invention includes the use of a variable or multi-speed compressor, a plurality of fixed capacity or speed compressors arranged in a compressor bank, a variable or multi-speed compressor with a plurality of refrigeration coils placed in vertical strata levels within the storage compartment, a plurality of fixed capacity or speed compressors arranged in a compressor bank with a plurality of refrigeration coils placed in vertical strata levels within the storage compartment operated by individual refrigerant media control valves, or a plurality of compressors (single or variable capacity or speed) with a plurality of refrigeration coils placed in vertical strata levels within the storage compartment coupled individually to a corresponding compressor, or combinations thereof.

All references, including publications, patent applications, and patents cited herein are hereby incorporated by reference to the same extent as if each reference were individually and specifically indicated to be incorporated by reference and were set forth in its entirely herein.

The use of the terms “a” and “an” and “the” and similar referents in the context of describing the invention (especially in the context of the following claims) is to be construed to cover both the singular and the plural, unless otherwise indicated herein or clearly contradicted by context. The terms “comprising,” “having,” “including,” and “containing” are to be construed as open-ended terms (i.e., meaning “including, but not limited to,”) unless otherwise noted. Recitation of ranges of values herein are merely intended to serve as a shorthand method of referring individually to each separate value falling within the range, unless otherwise indicated herein, and each separate value is incorporated into the specification as if it were individually recited herein. All methods described herein can be performed in any suitable order unless otherwise indicated herein or otherwise clearly contradicted by context. The use of any and all examples, or exemplary language (e.g., “such as”) provided herein, is intended merely to better illuminate the invention and does not pose a limitation on the scope of the invention unless otherwise claimed. No language in the specification should be construed as indicating any non-claimed claimed element as essential to the practice of the invention.

Preferred embodiments of this invention are described herein, including the best mode known to the inventors for carrying out the invention. Variations of those preferred embodiments may become apparent to those of ordinary skill in the art upon reading the foregoing description. The inventors expect skilled artisans to employ such variations as appropriate, and the inventors intend for the invention to be practiced otherwise than as specifically described herein. Accordingly, this invention includes all modifications and equivalents of the subject matter recited in the claims appended hereto as permitted by applicable law. Moreover, any combination of the above-described elements in all possible variations thereof is encompassed by the invention unless otherwise indicated herein or otherwise clearly contradicted by context.

What is claimed is:

1. A vending machine, comprising:
a product storage compartment configured to store products to be vended in an essentially vertical orientation such that products are vended from a bottom of the product storage compartment;
a variable capacity refrigeration system providing cooling to the product storage compartment;
a plurality of temperature sensors positioned at different vertical positions within the product storage compartment; and
a controller in communication with the plurality of temperature sensors to receive temperature information for the different vertical positions within the product storage compartment, the controller operatively coupled to the variable capacity refrigeration system to control operation thereof; and
wherein the controller operates the variable capacity refrigeration system to maintain the product storage compartment at a predetermined vend temperature for a predetermined learning period of time;
wherein the controller monitors an amount of products vended by the vending machine during the learning period to construct a vend profile; and
wherein the controller operates the variable capacity refrigeration system in accordance with the vend profile.

2. The vending machine of claim 1, wherein the controller includes a calendar function and a real time clock, and wherein the vend profile specifies product demand for an entire week.

3. The vending machine of claim 1, wherein the controller monitors actual demand for product from the vending machine after the learning period and logs instances of deviation in demand from that predicted by the vend profile.

4. The vending machine of claim 1, wherein the controller is in communication with an external network to receive information therefrom, and wherein the controller adjusts operation of the variable capacity refrigeration system based on the information.

5. The vending machine of claim 1, wherein the controller receives cost of energy information during the learning period, and wherein the controller constructs the vend profile based on the amount of products vended and the cost of energy.

6. The vending machine of claim 1, wherein the controller receives cost of energy information during the learning period, and wherein the controller adjusts operation of the variable capacity refrigeration system based on the cost of energy.

7. The vending machine of claim 1, further comprising an illumination system for the vending machine and a sensor, and wherein the controller is in communication with the sensor and operatively coupled to the illumination system to control operation thereof, wherein the controller turns on the illumination system when the sensor indicates that potential consumers are likely present and turns off the illumination system when the sensor indicates that potential consumers are likely not present.

8. The vending machine of claim 1, further comprising at least one inventory sensor, wherein the controller is further in communication with the at least one inventory sensor to receive inventory information therefrom, and wherein the controller monitors an inventory level and energy usage to determine a thermal gain and recovery profile.

9. The vending machine of claim 1, wherein the variable capacity refrigeration system comprises a variable or multi-speed compressor.

10. The vending machine of claim 1, wherein the variable capacity refrigeration system comprises a plurality of compressors arranged in a compressor bank.

11. The vending machine of claim 1, wherein the variable capacity refrigeration system comprises a variable or multi-speed compressor in fluid communication with a plurality of refrigeration coils positioned in vertical strata levels within the product storage compartment.

12. The vending machine of claim 1, wherein the variable capacity refrigeration system comprises a plurality of compressors arranged in a compressor bank in fluid communication with a plurality of refrigeration coils placed in vertical strata levels within the product storage compartment.

13. The vending machine of claim 12, further comprising a plurality of individual refrigerant media control valves coupled to the plurality of refrigeration coils to control operation thereof

14. The vending machine of claim 1, wherein the variable capacity refrigeration system comprises a plurality of compressors and a plurality of refrigeration coils placed in vertical strata levels within the storage compartment, and wherein the plurality of refrigeration coils are coupled individually to a corresponding one of the plurality of compressors.

15. A vending machine, comprising:
a product storage compartment configured to store products to be vended;
a variable capacity refrigeration system configured to provide temperature regulation to the product storage compartment;
a controller operatively coupled to the variable capacity refrigeration system to control operation thereof; and
wherein the controller operates the variable capacity refrigeration system to maintain at least a portion of the product storage compartment at a predetermined vend temperature.

16. The vending machine of claim 15, wherein the variable capacity refrigeration system comprises a variable or multi-speed compressor.

17. The vending machine of claim 15, wherein the variable capacity refrigeration system comprises a plurality of compressors arranged in a compressor bank.

18. The vending machine of claim 15, wherein the variable capacity refrigeration system comprises a variable or multi-speed compressor in fluid communication with a plurality of refrigeration coils positioned in vertical strata levels within the product storage compartment.

19. The vending machine of claim 15, wherein the variable capacity refrigeration system comprises a plurality of compressors arranged in a compressor bank in fluid communication with a plurality of refrigeration coils placed in vertical strata levels within the product storage compartment.

20. The vending machine of claim 19, further comprising a plurality of individual refrigerant media control valves coupled to the plurality of refrigeration coils to control operation thereof

21. The vending machine of claim 15, wherein the variable capacity refrigeration system comprises a plurality of compressors and a plurality of refrigeration coils placed in vertical strata levels within the storage compartment, and wherein the plurality of refrigeration coils are coupled individually to a corresponding one of the plurality of compressors.

22. A vending machine having a product storage compartment configured to store products to be vended therefrom, comprising a variable capacity refrigeration system configured to provide temperature regulation of at least a portion of the product storage compartment.
